(19) United States
(12) Patent Application Publication
(10) Pub. No.: US 2013/0159768 A1
(43) Pub. Date: Jun. 20, 2013

(54) SYSTEM AND METHOD FOR RESTORING DATA

(71) Applicants: Gavin Brent McKay, Manuka (AU); Allan John King, Manuka (AU); Damien Glenn Jolly, Manuka (AU)

(72) Inventors: Gavin Brent McKay, Manuka (AU); Allan John King, Manuka (AU); Damien Glenn Jolly, Manuka (AU)

(73) Assignee: INVIZION PTY LTD, Manuka (AU)

(21) Appl. No.: 13/566,280

(22) Filed: Aug. 3, 2012

(30) Foreign Application Priority Data
Aug. 3, 2011 (AU) 2011903085

(51) Int. Cl. G06F 11/14

(52) U.S. Cl. CPC G06F 11/1448
USPC 714/19

(57) ABSTRACT

A method for recovering data using metadata includes the steps of: receiving, at a storage location, data from a computing application; associating, at said storage location, metadata to said data received at said storage location; and storing said data and associated metadata in said storage location; wherein said data stored in said storage location is identifiable by said computing application using said metadata, thereby to recover said data in response to a data recovery event.

### CROSS-REFERENCE TO RELATED APPLICATIONS

This application claims priority to Australian Provisional Patent Application No. 2011903085, filed Aug. 3, 2011, the entirety of which is hereby incorporated by reference.

### FIELD OF THE INVENTION

The present invention relates to systems and methods for backing up electronic data. Some embodiments provide hardware and software components for the implementation of such systems and methods. More particularly, the invention is related to systems and methods for minimising data lost in a data recovery event.

### DESCRIPTION OF THE RELATED ART

The following discussion is intended to place the invention in an appropriate context, allowing the unique characteristics and advantages of it to be more fully understood. Therefore, reference to any prior art throughout this specification is not, and should not be taken as, an acknowledgement or any form of suggestion that such prior art forms part of the common general knowledge.

With the increasing proliferation of information technology, storage requirements have also increased. For modern IT infrastructure, it is not uncommon for an organisation to have multiple levels of storage, some of which may even be offsite. For example, individual employees may have access to a local hard drive on their workstation, and may also be able to access stored content on various servers in the corporate LAN, either through a network drive or through an internal intranet. Much of this content is also backed up according to one or more corporate policies. To enable data recovery in the event of a disaster, the backup itself is often also multi-tiered, with at least one tier of the backup being stored offsite and/or managed by a third party.

The corporate policy is generally administered by specialist IT professionals. In addition to specifying the type of data that is backed up, the life of the backup etc, it also specifies when and how many times a backup is run, that is, the backup schedule. The problem with such a setup is that it is impossible to recover all of the data which is lost in a data recovery event. This can be illustrated more clearly with an example: a typical data backup system backs up data on the hour between 8 am and 8 pm. A system failure occurs at 10:59 am, prior to a backup being run at 11:00 am. A traditional data backup system would only be able to restore data from 10:00 am, resulting in 59 minutes of lost data.

### SUMMARY

It is an object of the present invention to provide or ameliorate one or more of the disadvantages of the prior art, or at least provide a useful alternative.

It is an object of embodiments of the present invention to provide a system and method of backing up data that minimizes the data lost in a data recovery event.

It is also an object of embodiments of the present invention to provide a system and method of backing up data that is capable of restoring data in near real time.

According to one aspect of the present invention there is provided a method for recovering data using metadata, the method comprising the steps of:
receiving, at a storage location, data from a computing application;
associating, at said storage location, metadata to said data received at said storage location; and
storing said data and associated metadata in said storage location;
wherein said data stored in said storage location is identifiable by said computing application using said metadata, thereby to recover said data in response to a data recovery event.

According to another aspect of the present invention there is provided a system for recovering data using metadata, said system having a storage location for receiving data from a computing application, said storage location comprising:
a receiver for receiving said data from said computing application;
a processor for associating metadata to said data received at said storage location;
memory for storing said data and associated metadata; and
a transmitter for transmitting said data from said server location to said computing application;
wherein said data stored in said storage location is identifiable by said computing application using said metadata, thereby to recover said data in response to a data recovery event.

Preferably, the computing application is executable on a consumer device. The data is preferably rebuilt on the consumer device in near real-time. Preferably, the consumer device is one of: a personal computer; a mobile telephone, a tablet or a like device adapted for communication on a data network.

The data recovery event preferably comprises a disaster event resulting in loss of data. Preferably, in the data recovery event, the metadata is extracted from the storage location and transmitted to a data recovery system for analysis.

Preferably, the data recovery system rebuilds the data on the consumer device by identifying the data based on the analysis of the metadata. The data is preferably rebuilt with the metadata associated thereto. Preferably, the “associating” comprises appending the metadata to the data.

The storage location is preferably located remotely with respect to the consumer device.

Further features and aspects of example implementations are described in additional detail below with reference to the appended Figures.

### BRIEF DESCRIPTION OF THE DRAWINGS

The present invention will now be described in a non-limiting manner with respect to a preferred embodiment in which:

FIG. 1 is an overview of a system for restoring data using metadata according to one aspect of the present invention;

FIG. 2a is a schematic diagram of metadata being appended to a data file according to one aspect of the present invention;

FIG. 2b is a schematic diagram of metadata being extracted from a data file according to one aspect of the present invention; and

FIG. 3 is a flow diagram showing logical steps of a method for restoring metadata according to one aspect of the present invention.

### DETAILED DESCRIPTION OF PREFERRED EMBODIMENTS

Described herein are various systems and methods for backing up data. In overview, when data is backed up at a storage location, it is associated with metadata that is configured to identify the data. If the data on the consumer system is corrupted or otherwise damaged, it can be restored by accessing the backed up data at the storage location. According to embodiments of the present invention, a storage system accesses the metadata to identify the data to be restored, and forwards it on to the consumer system.

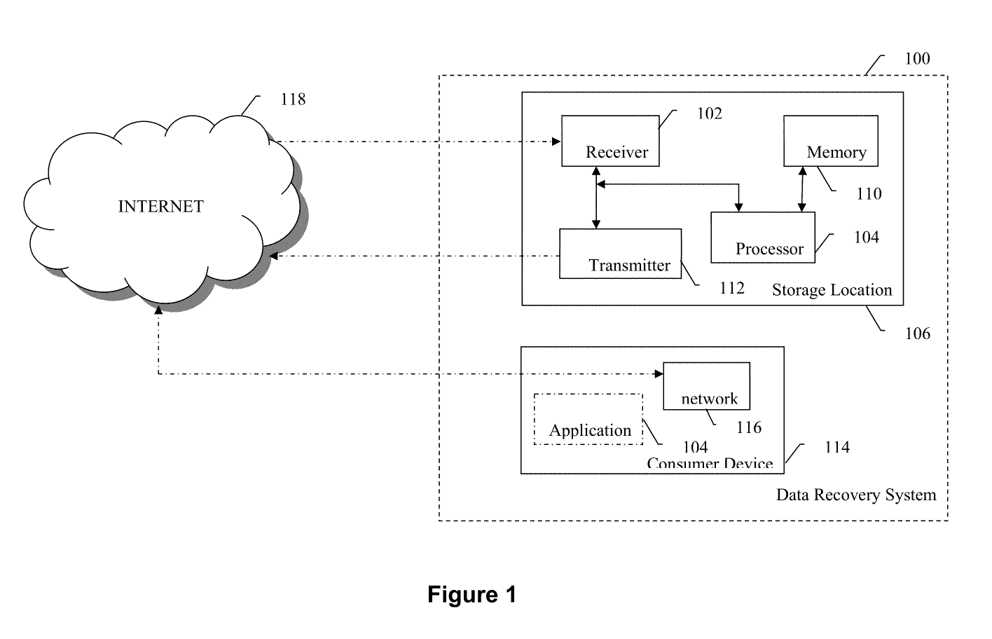

Referring to FIG. 1, the system 100 for recovering data using metadata includes a receiver 102 for receiving data from a computing application 104 at a storage location 106, which includes a processor 108 for associating metadata with the received data. The storage location also includes a memory 110 for storing the data and associated metadata, and a transmitter 112 for transmitting the data from the storage location 106 to the computing application 104. The data stored in the storage location 106 is identifiable by the computing application 104 using the metadata, and is thereby recoverable in response to a data recovery event.

The term “data”, as used herein, includes electronic information commonly used in an IT environment. Such electronic information also known as a “file”, and may be a document, spreadsheet, brochure, presentation, email or the like. Throughout this specification and in the claims, the terms “data” and “file” will be used interchangeably.

Again referring to FIG. 1, the storage location 106 is in communication with a computing application 104, which is executed on a consumer device 114. In embodiments, the consumer device is one of: a personal computer; a mobile telephone, a tablet or a like device adapted for communication on a data network, for example, through network interface 116. In this embodiment, the consumer device communicates with the storage location through the internet 118. However, it will be appreciated that this is not the only way consumer device 104 can communicate with the storage location 106. Those skilled in the art will readily know alternative ways through communication can occur. In use, files generated by the consumer application 104 are backed up according to a backup schedule. The purpose of backing up data is so that in a data recovery event such as a disaster resulting in loss of said data, the data can be restored and the IT system can be restored to its normal configuration with minimal disruption. In most embodiments, backing up involves maintaining separate copies of each file in the IT system at separate locations.

In some embodiments, however, such as systems and methods discussed in international patent application number PCT/AU2010/000512 assigned to the present applicants, the data to be backed up is organized into tiers, wherein the files are assigned a ranking, and backed up files are stored in a storage location in the tier corresponding to the file rank. In this system, multiple copies of files assigned the highest ranking may be stored at multiple storage locations, while files assigned the lowest may not be backed up at all.

In yet other embodiments, multiple backups of all files are stored at multiple backup locations. A first storage location may be located on premises for convenient access, while a second storage location may be located remotely for greater redundancy. Those skilled in the art will recognize that the present invention is not limited to using two storage locations, and that the present system is adaptable for use with many more storage locations for even greater redundancy.

Data backup systems utilize a number of data repository models. Generally, these models separate the task of the actual storage of the file and the task of organising the stored files.

Organisation of the stored files can be as simple as a list of file names written on a piece of paper. However, more common are backup systems with more sophisticated setups, such as those with a computerized index, catalogue or even a relational database. For these systems, once a particular file is stored in the storage location, the electronic index is updated so that the location of the file is documented by the data recovery system.

In one embodiment, in a data recovery event, the data recovery system directly accesses the storage location, extracts the metadata and transmits it to the consumer device for analysis. In this analysis, the data recovery system identifies the files that are to be restored by analysing the extracted metadata. Once the files are identified, they are retrieved from the storage location, rebuilt and restored onto the consumer device.

It should be noted that in this embodiment, both the computing application and the data recovery system are executable on the consumer device. However, in alternate embodiments, the data recovery system may be an application executable at the storage location, or even a standalone hardware device. Those skilled in the art will readily appreciate that the data recovery system can be implemented in a number of alternate ways.

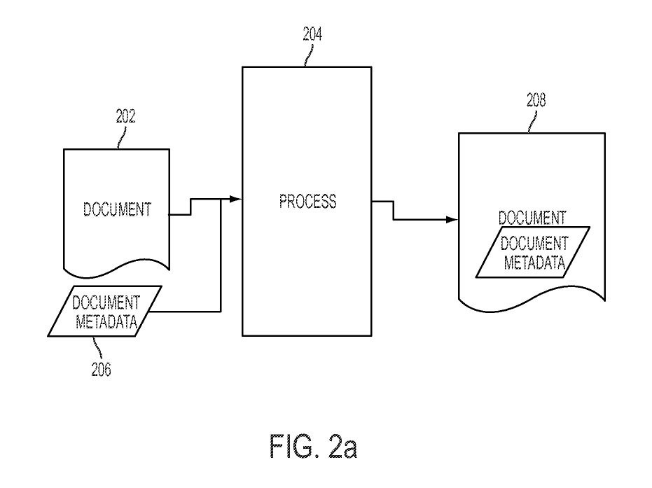

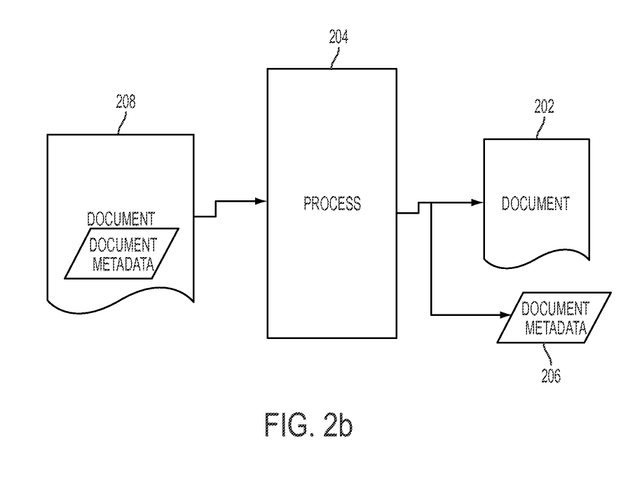

A more specific example is illustrated in FIGS. 2a and 2b. A file, for example document 202, is generated by a computing application such as Microsoft WORD. When document 202 is backed up, for example according to a backup schedule, the backup process 204 appends metadata file 206 to the document 202. The resulting backup file 208 that is stored at the storage location 106 is a combined file that contains both the original document 202 and the metadata file 206.

In this example, the individual WORD document file 202 can be restored from directly within the application. A user may first select a WORD document to open, only to find that the file has been corrupted and therefore cannot be accessed. In response, the WORD application accesses the data recovery system 100 and requests a backup file 208 which is a copy of the document 202.

Following receiving the request from the WORD application, the data recovery system 100 accesses the storage location 106 and executes backup process 204 to extract the metadata file 206 from the backed up file 208. The process then analyses the metadata to locate the desired file. Once the file is located, it is retrieved from the storage location and sent back to the WORD application, which then opens the document within the application.

Therefore, in this example, the backed up document filed is retrieved in near real-time without the user having to directly access the data recovery system to undertake any specific “restore” operations.

The document files in this example are rebuilt with the metadata associated thereto. However, in other embodiments it will be apparent to those skilled in the art that the rebuilt files need not be associated with any metadata.

Moreover, in the preferred embodiment, the association occurs by appending the metadata to the files. Of course, those skilled in the art will appreciate that the association between data and metadata can occur in many ways, such as by prepending the metadata, by inserting the metadata into the file, by dynamically linking the metadata to the file, or the like.

Furthermore, because the backups are not run according to a schedule, no files are lost. Backups according to the present invention can occur in near-real time, whereas prior art backup systems have a window during which data may not be backed up.

In practice, as will be shown in the specific examples below, it is envisaged that one embodiment of the present system would be used to supplement existing backup systems, so that analysis of the metadata can be minimized. That is, as discussed in the background section above, a backup may run according to a backup schedule such as once every hour, on the hour. If a data recovery event occurs at 10:59 am, the last backup which occurred at 10:00 am will be restored, resulting in 59 minutes of lost data.

Once the 10:00 am backup is restored, the data recovery system will be notified that 59 minutes of data cannot be accounted for. The data recovery system will then access the backed up files directly, and extract the metadata stored in the storage location. It will then analyse the metadata and categorize those files having a timestamp within the last 59 minutes. Using the metadata, the data recovery system will identify the corresponding files, locate where they are stored at the storage location, retrieve them and restore them onto the consumer device.

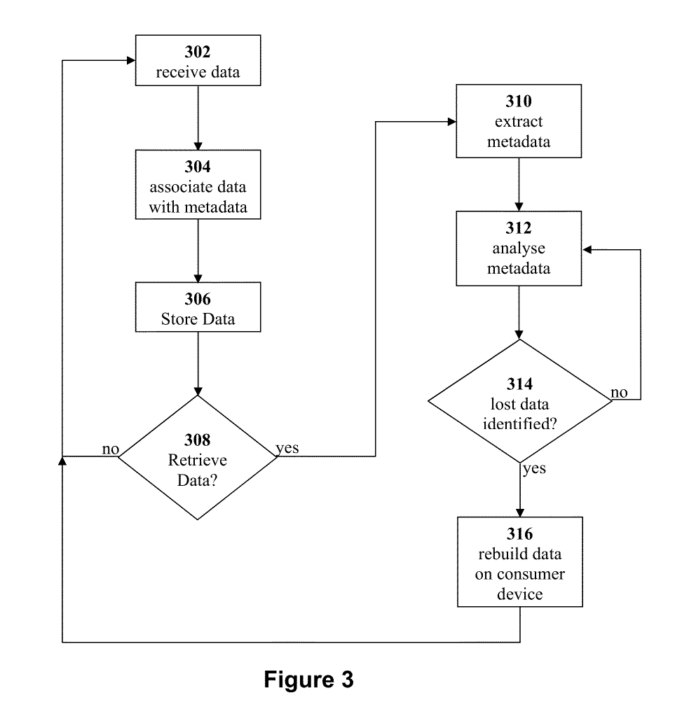

The method according to embodiments of the present invention can be more clearly illustrated with reference to the flow chart of FIG. 3, in which:
At step 302, the system receives the files to be backed up at the storage location;
At step 304, the system runs a back up process to append metadata to the each of the files to create a respective number of backup files;
At step 306, the backup files are stored at the storage location;
The system waits for a retrieve data request at decision block 308.
If the system receives a request to retrieve data, at step 310, it runs a process to extract the metadata from the backup files. Otherwise, the system continues to receive files to be backed up and returns to step 302;
At step 312, the process analyses the metadata;
If the system identifies the lost data at decision block 314, it rebuilds the data on the consumer device at step 316. Otherwise, the system returns to step 312 and continues to analyse the metadata;
Finally, once the lost data is rebuilt, the system returns to step 302 and continues to receive files to be backed up.

Embodiments of the present invention are also further described through the following examples. In the following examples, the generic term “data recovery system” is known as “StepWise”, which is the marketing name applied to the applicant's data recovery product. The content database, which is where backed up files are actually stored, is a deployment of Microsoft SharePoint Server.

In the first example, the hypothetical company, “Acme Inc.”, realizes that their StepWise management database is corrupt and cannot be repaired. They are able to restore data from the last backup, but realize that they have lost about 1 hour's worth of data.

For this example, the SharePoint Content Database as well as the storage SAN are both intact. The backup database is restored and reconnected to the StepWise Management System. The StepWise administrator is then able to run a StepWise Disaster Recovery program, available within the StepWise product suite, that audits files in the SAN and discovers files that were added during the hour that data was lost from the database. The StepWise administrator is presented with a report on the missing files which contains a complete copy of all metadata that is stored with the files on the storage location. The StepWise Administrator then has the option of rebuilding missing entries on the Disaster Recovery program, and the StepWise management database is restored.

In this example, the result is that there is only minimal downtime, and that no files are lost. StepWise can also automatically regenerate missing entries from the storage tiers at the storage location.

In the next example, Acme Inc. realizes that their StepWise management database is corrupt and cannot be repaired, and worse still the last week's worth of backups are unusable. They are able to restore from a backup that is a week old, but realize that they have lost 1 week's worth of changes to the StepWise Management Database. Again, the SharePoint Content Database is intact, as is the storage SAN. The backup database is restored and reconnected to the StepWise Management System. The StepWise administrator is then able to run a StepWise Disaster Recovery program, available within the StepWise product, that audits files in the SAN and discovers files that were added during the week that data was lost from the database.

The StepWise administrator is presented with a report on the missing files which contains a complete copy of all metadata that is stored with the files on the storage tiers. The StepWise Administrator again has the option to rebuild missing entries on the Disaster Recovery program, and the StepWise management database is restored.

The result of this example is that there is only minimal downtime and that no files are lost. StepWise can again automatically regenerate missing entries from the storage tiers at the storage location.

In the third example, Acme Inc. is notified that their Tier 1 Storage device has broken down. All files on the storage tier are lost, however, they do have a working backup that was taken the previous night.

The StepWise Enterprise Storage Administrator reviews the Storage Tiers and notes that the StepWise Management system has automatically failed over content storage to the Tier 2 storage tier. Users are able to continue to store documents, however, the outage causes all documents on the Tier 1 storage device to return a “Not Found” error to users. The SharePoint and StepWise Administrators notify staff of the outage and connect to the replicated storage tier.

When the Tier 1 restore has completed, the StepWise administrator reattaches the storage device to the StepWise Management System, and access to the documents on the Tier 1 storage is restored. The StepWise Administrator runs the Disaster Recovery program, and StepWise scans the attached SharePoint systems for missing files. A report is generated for the missing files, and the SharePoint Administrator is notified.

The result in this example is that there is no downtime, and only a minimal loss of files. StepWise automatically fails-over to the next available tier of storage at the storage location.

It will be appreciated that embodiments of the present invention described herein provide a system and method of backing up data that minimizes the data lost in a data recovery event.

It will also be appreciated that embodiments of the present invention described herein provide a system and method of backing up data that is capable of restoring data in near real time.

It is to be understood that the above embodiments have been provided only by way of exemplification of the present invention, and that further modifications and improvements thereto, as would be apparent to persons skilled in the relevant art, are deemed to fall within the broad scope and ambit of the current invention described and claimed herein. It is also to be understood that any of the features described herein may be used and/or provided in any combination.

Throughout this specification and in the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. Similarly, unless the context requires otherwise, the word “include”, and variations such as “includes” and “including”, will be understood to be synonymous with the word “comprising” and its corresponding variations.

What is claimed is:

1. A method for recovering data using metadata, the method comprising the steps of:
receiving, at a storage location, data from a computing application;
associating, at said storage location, metadata to said data received at said storage location; and
storing said data and associated metadata in said storage location;
wherein said data stored in said storage location is identifiable by said computing application using said metadata, thereby to recover said data in response to a data recovery event.

2. A method according to claim 1 wherein said computing application is executable on a consumer device.

3. A method according to claim 2 wherein, in said data recovery event, said metadata is extracted from said storage location and transmitted to a data recovery system for analysis.

4. A method according to claim 3 wherein said data recovery system rebuilds said data on said consumer device by identifying said data based on said analysis of said metadata.

5. A method according to claim 4 wherein said data is rebuilt with said metadata associated thereto.

6. A method according to claim 4 wherein said data is rebuilt on said consumer device in near real-time.

7. A method according to claim 1 wherein said associating comprises appending said metadata to said data.

8. A method according to claim 1 wherein said storage location is located remotely with respect to said consumer device.

9. A method according to claim 2 wherein said consumer device is one of: a personal computer; a mobile telephone, a tablet or a like device adapted for communication on a data network.

10. A method according to claim 1 wherein said recovery event comprises a disaster event resulting in loss of said data.

11. A system for recovering data using metadata, said system having a storage location for receiving data from a computing application, said storage location comprising:
a receiver for receiving said data from said computing application;
a processor for associating metadata to said data received at said storage location;
memory for storing said data and associated metadata; and
a transmitter for transmitting said data from said server location to said computing application;
wherein said data stored in said storage location is identifiable by said computing application using said metadata, thereby to recover said data in response to a data recovery event.

12. A system according to claim 11 wherein said computing application is executable on a consumer device.

13. A system according to claim 12 wherein, in the event of disaster recovery, said metadata is extracted from said storage location and transmitted to a data recovery system for analysis.

14. A system according to claim 13 wherein said data recovery system rebuilds said data on said consumer device by identifying said data based on said analysis of said metadata.

15. A system according to claim 14 wherein said data is rebuilt with said metadata associated thereto.

16. A system according to claim 14 wherein said data is rebuilt on said consumer device in near real-time.

17. A system according to any one of claim 11 wherein said associating comprises appending said metadata to said data.

18. A system according to claim 11 wherein said storage location is located remotely with respect to said consumer device.

19. A system according to claim 12 wherein said consumer device is one of: a personal computer; a mobile telephone, a tablet or any like device adapted for communication on a data network.

20. A system according to claim 11 wherein said recovery event comprises a disaster event resulting in loss of said data.
